(19) United States
(12) Patent Application Publication
(10) Pub. No.: US 2017/0121511 A1
(43) Pub. Date: May 4, 2017

(54) A PROCESS TO PREPARE HIGH-QUALITY NATURAL RUBBER SILICA MASTERBATCH BY LIQUID PHASE MIXING

(71) Applicants: Junjuan LI, Hengshui, Hebei (CN); Lujun YOU, Hengshui, Hebei (CN); Solomon Hsing-Kuo TANG, Pearland, TX (US)

(72) Inventors: Junjuan LI, HENGSHUI (CN); Lujun YOU, HENGSHUI (CN); Solomon Hsing-Kuo TANG, Pearland, TX (US)

(21) Appl. No.: 14/907,279

(22) PCT Filed: Jul. 22, 2014
(86) PCT No.: PCT/US14/47646

§ 371 Date: Jan. 23, 2016

(51) Int. Cl. C08L 9/08; C08J 3/22; C08L 7/02

(52) U.S. Cl. CPC C08L 9/08; C08L 7/02; C08J 3/22; C08L 2310/00; C08J 2307/02; C08J 2409/08; C08J 2309/08; C08J 2407/02

(57) ABSTRACT

The present invention relates to a process for making a polymer masterbatch with silica nanoparticles highly uniformly dispersed therein by using a stable aqueous emulsion of compatibilized silica nanoparticles, the sizes of which are mechanically reduced to nanoscales. Adequate reduction of the silica particles to nanoscales is essential for the formation of a desired emulsion of highly stability. The said emulsion of compatibilized silica nanoparticle can be easily mixed under mild conditions with a polymer in latex form, which can be high purity natural rubber, synthetic rubber and/or a blend thereof. The bifunctional organosilane coupling agent bonded-Silica nanoparticles are subsequently incorporated into the rubber polymer network during coagulation with formic acid. The inventive rubber-silica masterbatch thus obtained is useful for manufacturing rubber and other polymer composite products.

### CROSS REFERENCE TO RELATED APPLICATIONS

The present application claims priority to and the benefit of U.S. Provisional Patent Application Ser. No. 61/857,816 filed on Jul. 24, 2013, titled “A process to prepare high-quality rubber-silica wet masterbatch”, which is hereby incorporated by reference in its entirety.

### FIELD OF THE INVENTION

The embodiments of the present invention generally relate to the polymer compositions of a class of masterbatches prepared through incorporating compatibilized silica nanoparticles into natural rubber and synthetic polymers in latex forms and the preparation processes for said masterbatches.

### BACKGROUND AND RELATED ART

To improve physicochemical properties of a rubber, elastomer or other thermoplastic polymer product, it is highly desirable to introduce reinforcing agents and/or fillers into such products. For instance, silica and carbon black have been commonly used as reinforcing agents/fillers in the manufacturing processes for rubber products, such as tires. The addition of such agents/fillers can help to (a) satisfy certain requirements of the manufacturing processes, (b) reinforce/improve the mechanical properties of the resultant polymer products and (c) reduce the production costs.

Currently in rubber manufacturing processes, the conventional fillers used include, among others, carbon black, silica, fiber, clay and calcium carbonate. Here, carbon black and silica are used to reinforce the mechanical strength of natural rubber. Carbon black is a colloidal form of elemental carbon and is produced by partial combustion of oil or natural gases. Clusters of carbon black particles fuse together to form (primary) aggregates, which, in turn, flocculate together to form larger secondary agglomerates. These agglomerates are held together by Van der Waals forces of attraction. When the filler (carbon black) is added to the matrix of the elastomer (rubber), the sources of reinforcement between the two is also the Van Der Waals force attraction. Here, because carbon black consists of semi-crystalline aggregates formed under heat in a very short period, the interactions among the carbon black particles are weaker than those among the rubber matrix and carbon black particles. In addition, rubber chains are grafted onto the carbon black surface by covalent bonds, caused by a reaction between the functional group at the carbon black particle surface and free radicals on polymer chains. Therefore, the filler-rubber interface here is made up of complex physicochemical interactions. Furthermore, the adhesion at the rubber-filler interface also affects the reinforcement of rubber. As a result of the tendency for carbon black to easily disperse into the rubber matrix, it has an excellent ability to reinforce the mechanical properties of rubber without the need of using organosilane-type coupling agents.

Silica has been used less than carbon black as a reinforcing filler for rubber, but is growing tremendously in use, especially in the tire industry. It has been found that the use of silica can reduce tire rolling resistance by approximately 20% relative to carbon black, which corresponds to approximately 3-4% fuel savings. In addition, silica, being more elastic and flexible at relatively low ambient temperatures, can provide substantial benefits in winter tires leading to better grip and braking. The main draw back for silica as a filler for rubber products comes from its strong inter-particle forces, making it difficult to obtain a good dispersion within the rubber matrix. The surface of precipitated silica tends to be hydrophilic, as a result of its surface silanol (Si—OH) groups causing the formation of hydrogen bonds between aggregates and agglomerates. The hydrophilic nature of the silica surface and the tendency to form hydrogen bonds lead to a high inter-particle interaction which prevents its easy dispersion during mixing and results in a poor compatibility between the silica and the rubber matrix. As a result, the use of coupling agents, such as bifunctional organosilanes, is necessary for silica to be used as a reinforcing agent for rubber. The function of the bifunctional organosilane coupling agents is derived from their ability to chemically bond to both with the silica and rubber during the mixing and subsequent vulcanization stages, respectively.

Several techniques have been developed to incorporate such reinforcing agents and fillers into polymer compositions, including both dry and wet blending processes. The most commonly used method in commercial scales is dry blending the fillers, either silica, carbon black or both, into the rubber and thermoplastic polymers in a high-shear mixing operation. Such technique has many limitations, especially due to the tendency for the filler particles to agglomerate to each other, thus leading to poor dispersion of the filler particles throughout the polymer matrix. Along a similar line, the techniques of simple wet blending of the silica with polymer lattices can be rather ineffective and problematic in that the hydrophilic silica has a tendency to associate with the aqueous phase and not blend uniformly with the hydrophobic polymer phase and other fillers and ingredients present.

In contrast to the aforementioned simple dry or wet mixing processes of directly incorporating the silica into rubber, it can be first incorporated in higher concentrations into the matrix of polymers, such as the rubber, to form a rubber-silica masterbatch, which, in turn, can be mixed with the natural or synthetic rubber latex together with other ingredients, such as process oil and other inert materials, that are typically present in rubber compounding and the mixture is then vulcanized to give a wide range of rubber articles, such as tires, anti-vibration and support automobile parts, sleeves and belts for automobile and mechanical uses, flooring tiles and floor supports, shoe soles and sporting goods. By definition, a rubber-silica masterbatch is a combination product of the filler (silica) and polymer (rubber) and, optionally, other compounding ingredients. While a number of commercially available carbon black masterbatches are currently available for making polymer composites, especially emulsion styrene-butadiene rubber (ESBR), there is, to the best of our knowledge, no known commercially available silica masterbatch. This is believed to relate to several underlying problems, most of which are caused by the lack of means to achieve sufficient and effective interactions of the silica, which is hydrophilic in nature, with non-polar polymers, such as SBR.

Industrially, rubber can be made in an emulsion or wet process in water, or in a solution process in an organic solvent. As discussed above, the main reason for why simply mixing silica with a rubber latex followed by coagulation does not work is when the untreated silica is added either to an emulsion of SBR (in the emulsion or wet process) or to a solution of SBR in an organic solvent (in the solution process), the silica, inevitably, fails to completely incorporate into the polymer matrix. Instead, the silica tends to separate as fines when the rubber coagulates, resulting in many processing problem. Instead, the following two objectives have to be achieved in order to develop a successful rubber making process through the preparation and use of a rubber-silica masterbatch: a) there exists a process of hydrophobating the silica, which is the treatment of the surface with an bifunctional agent to make the silica more compatible with the rubber matrix, and b) once attached to the silica, the bifunctional agent should be capable of interacting with the cure system of the rubber to achieve bonding of the rubber to the silica during the curing process so that the silica does not agglomerate, and thus provides effective wear resistance in the rubber composite.

There have been many efforts aiming at improving the interactions of silica with polymer matrixes so that a viable rubber-silica masterbatch can be obtained. Such efforts can be traced back to about 40 years ago when it was disclosed by Burke in a series of US patents (e.g., U.S. Pat. Nos. 3,686,113 and 3,840,382) that silica can be hydrophobated with organic acids, amines or ammonium salts of carboxylic acids and subsequently be used to make rubber-silica masterbatch. This provided a solution for the problem of incorporating silica into rubber, but still failed to provide a solution for the problem of incorporating the silica into rubber composite during vulcanization. To solve the latter, Lightsey el al. disclosed, in another series of US patents (e.g., U.S. Pat. Nos. 5,763,388 and 5,985,953), certain technical improvements involving hydrophobating the silica with an aqueous solution of an organosilane which could form a covalent bond with the rubber. However, that technology required the use of 3-mercaptopropyl silane, a material known to reduce scorch times when being used in conventional silica mixing. Further, still more critical issues had to be solved for commercially viable silica masterbatches to become reality. One of such issues is the capability of any such technology to enable the incorporation of high levels of silica, without which the technology cannot be deemed practical because it does not permit tire manufacturers to use silica at the required levels for making tires.

Clearly, there is a need to provide a simple, effective and low cost technique for the highly uniform incorporation of silica (with or without other fillers) into natural and synthetic polymer, such as rubber, at the latex stage that can reduce sulfur content in the resultant rubber. There is also the need to provide a process for the incorporation of silica reinforcing agent into natural and synthetic polymers at the latex stage in which the silica particles are nano-sized such that the resultant silica nanoparticles can be substantially uniformly dispersed into and become an intimate part of the stable polymer composite network formed during the processing for end use. Typically, a nano-sized particulate material contains particulates having a diameter ranging from 10 to 50 nanometers. Additionally, there exists a need to provide a simple and effective process for the preparation of the desirable highly uniform dispersions of the silica nanoparticles being compatible with natural and synthetic polymers, such as rubber, by having bifunctional organosilane coupling reagents chemically bonded on the silica surface and into the polymer network. Finally, there remains a need to provide an emulsion process for the preparation of a rubber-silica masterbatch in which the silica particles are nano-sized, and the desired masterbatch can be economically manufactured and will effectively bind silica to rubber during the vulcanization process and ultimately produce the desired rubber-silica masterbatch having superior properties.

As will be disclosed in details below, the current invention provides a unique coprecipitation process for the preparation of such a desired rubber-silica masterbatch. To date, there are no publications or disclosures of patent/application of a manufacturing process for rubber composites through the use of rubber-silica masterbatch obtained by coprecipitation in an emulsion process of a highly uniform dispersion in a natural rubber matrix of compatibilized silica particles, the particle size of which had been mechanically reduced to nanoscales. Related prior disclosures are limited to those for processes involving natural rubber and regular sized silica particles, with or without added nano-sized calcium carbonate, or natural rubber and carbon black, or natural rubber and silica simple composites.

For instance, U.S. Pat. No. 8,357,733 issued to Wallen and co-workers disclosed a process for making silica-filled rubber masterbatch using silica hydrophobated with a mixture of trimethoxy silane coupling agents in an suspension at elevated temperatures, one or more of which react with rubber to bond the silica to the rubber, and one or more of which do not react with rubber, but do hydrophobate the silica. The resulting compatibilized silica in an aqueous slurry was mixed with a natural or synthetic rubber latex and the resulting mixture was further agitated at elevated temperatures before being subjected to coagulation to form a rubber-silica masterbatch, which was asserted to provide a long scorch time and can thus be processed for a long time before scorching. Similarly, U.S. Pat. No. 8,741,987 issued to Harris and co-workers disclosed a polymer masterbatch prepared in the latex form by using compatibilized silica and additional nanomaterials for incorporation into natural and synthetic polymers in the latex form. The disclosed process used precipitated or fumed silica with at least two organo-silicon coupling compounds attached to the silica in an aqueous suspension at elevated temperatures. The resulting compatibilized silica in an aqueous slurry was then introduced into a natural or synthetic rubber latex and the resulting mixture was further agitated at elevated temperatures before being subjected to coagulation to form a rubber-silica masterbatch, which was asserted to be effective for use with natural and synthetic rubber lattices and for incorporation into a continuous or batch emulsion polymerization process at the latex stage. Furthermore, published US patent application No. 2013/0203914 by Debnath and co-worker disclosed a highly loaded silica wet masterbatch utilizing dry precipitated silica treated with a plurality of silanes coupling agents to form a wet polymer silica masterbatch.

Nonetheless, other people, including the present inventors, have found it difficult, even with preparation methods (such as those disclosed in the aforementioned US patents) asserted to be effective, to prepare, in an industrial scale, a highly uniform dispersion of compatibilized silica in an emulsion, which is easily mixed with a polymer latex to further prepare a polymer-silica masterbatch with desirable physicochemical characteristics. While not wishing to be bound by any particular theoretical explanation of the phenomena, it is believed that the poor performance of the above-mentioned methods, as well as similar methods of other related prior disclosures, results from the lack therein of an effective and efficient means to reduce the sizes of the compatibilized silica particles into nanoscales to facilitate their uniform dispersion into an emulsion that can be very effectively mixed with a polymer latex to prepare the masterbatch.

### SUMMARY OF THE INVENTION

The present invention provides, in one aspect, a process for the preparation of a rubber-silica masterbatch through the use of a process where fine silica particles are fully mixed with, and hydrophobated/compatibilized first by, an appropriate bifunctional organosilane coupling agent and the resulting modified silica particles are further reduced by an appropriate grinding device to nano-scales in an aqueous emulsion, such that a highly uniform dispersion of the compatiblized silica nanoparticles in the emulsion is achieved, ready to be incorporated, under even a mild condition, into the matrix of a high-quality natural or synthetic rubber or blends. The compatibilized silica nano-particles thus prepared according to the present invention can be essentially completely incorporated into the resulting masterbatch with no loss of silica.

An objective for the present invention is to provide a process to improve the dispersion of silica in natural rubber latex, leading to a rubber—silica masterbach through coprecipitation, which is a highly uniform dispersion of silica in a natural rubber and/or rubber blend to further provide efficient crosslinking of the silica into the rubber polymer network, thereby significantly improving the physical and mechanical properties and dynamic mechanical properties of the rubber—silica masterbatch thus obtained. The rubber-silica masterbatch made according to this invention can further be used in rubber compounding resulting in very desirable physical and mechanical properties and superior qualities of the rubber composite products. The reduction, through grinding, of the particle sizes for the compatibilized silica is extremely important here, as the smaller the particle size, the more stable the dispersion of the nanoparticles in the resulting emulsion. As a result, the compatibilized silica emulsion can then be easily dispersed uniformly into the rubber matrix in latex form. While not wishing to be bound by any particular theoretical explanation, it is believed that this is where the methods in prior disclosures, such as those above-mentioned related arts, are lacking Untreated, or pretreated precipitated silica products normally exist as granules for ease of handling and to minimize the associated severe Environmental, Health and Safety (EHS) issues in plants (which can arise from dust of silica if not as granules).

In another aspect, the present invention provides a process for making rubber and other polymer composites based on preparing a rubber-silica masterbatch obtained through coprecipitation of the aforementioned highly uniform dispersion of compatibilized silica nanoparticles in the latex of natural rubber/rubber blends. As compared to other traditional processes, the production process according to the present invention for making rubber/polymer composites is simpler, easier to control and pollution-free, while saving time and energy.

In one embodiment of the present invention, fine silica particles to be hydrophobated are directly mixed and reacted with a proper bifunctional organosilane coupling agent. The mixing and reaction to compatibilize the silica particles are carried out in in a helical ribbon mixer/blender at an elevated temperature for an appropriate time. The particle sizes of the resultant compatibilized/hydrophobated silica prepared accordingly are reduced in a horizontal grinder together with a dispersing agent to nanometer scales, which ultimately results in a stable aqueous emulsion of the compatibilized silica nanoparticles. The emulsion of the compatibilized silica nanoparticles prepared according to the current invention has the advantage of affording a more intimate mixing of the compatibilized silica particles with the rubber in latex form, and ultimately, the desired masterbatch structure of highly uniform incorporation of silica into the rubber network with more and stronger cross-linking bonds while significantly decreasing the loss of silica during the subsequent steps of the process.

In another embodiment, the resulting emulsion with compatibilized silica nanoparticles highly uniformly dispersed therein is added with mixing under ambient temperature (without taking any special measures) to a high-quality natural rubber latex (or mixture of high-quality natural rubber latex and styrene butadiene rubber latex), and optionally, with other compounding ingredients as needed prior to the next coagulation step. The mixture thus obtained is then flocculated with an acid to effect the precipitation. The precipitated gel-like soft solid is then neutralized and washed followed by de-watering by pressing and drying to form a high-quality rubber-silica masterbatch.

In still another embodiment, the resulting silica masterbatch is mixed with other ingredients used in rubber compounding and vulcanized to give rubber articles, especially tires. Other embodiments and advantages of the present invention will become apparent to those skilled in the art upon a review of the following detailed description of exemplary embodiments of the invention.

### BRIEF DESCRIPTION OF THE DRAWING

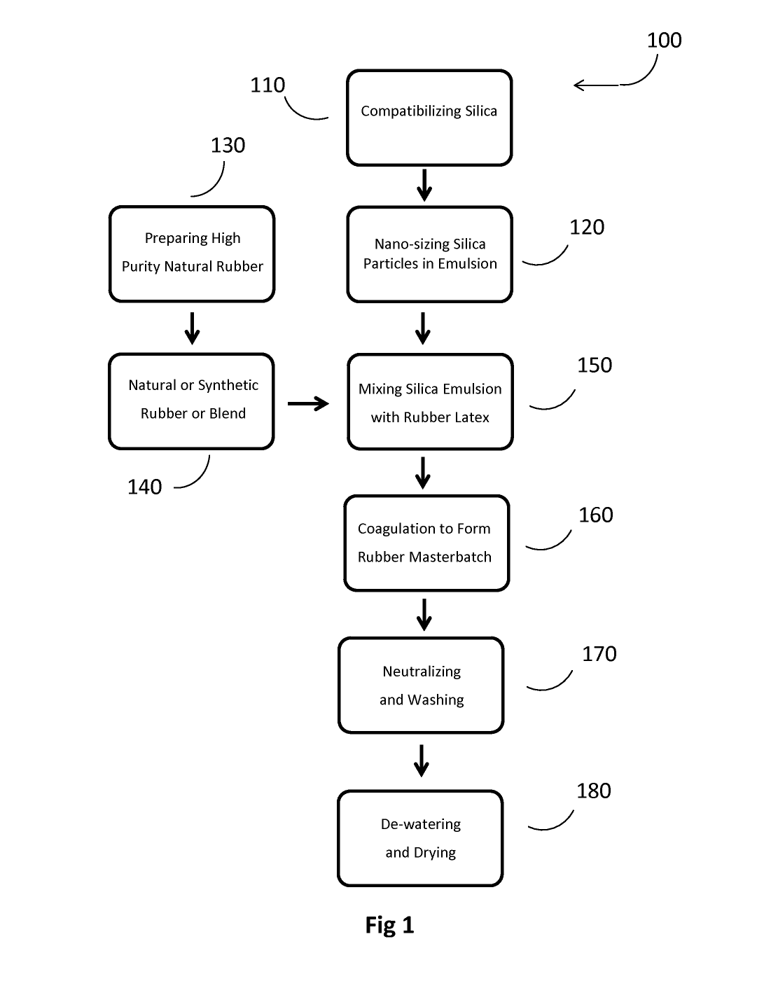

A preferred embodiment of the present invention will now be described, by way of example only, with reference to the accompanying drawing, wherein: FIG. 1 is a method flow diagram, which shows an emulsion Process 100 to prepare a rubber masterbatch filled with highly uniformly dispersed silica nanoparticles, as claimed herein. The steps in Process 100 are preferably performed by first compabilize silica filler particles with a bifunctional organosilane coupling agent (step 110). Next, mechanically reduce the silica particle size to nanoscales in an emulsion to achieve highly uniform dispersion and encapsulation (step 120). In parallel, prepare a natural rubber latex of high purity (step 130). Optionally, a synthetic rubber latex or its blend with the natural rubber latex can be prepared (step 140) to be mixed with the emulsion of silica nanoparticles (step 150). Then coagulate the resulting mixture to form the desired rubber masterbatch as a gel-like solid with silica nanoparticles highly uniformly dispersed therein (step 160). The masterbatch goes through neutralization and washing (step 170), followed by de-watering and finally drying (step 180) to afford the desired product of rubber-silica masterbatch.

### DETAILED DESCRIPTION OF THE INVENTION

The present invention provides in one embodiment a process for making the compatibilized (hydrophobated) silica in a stable aqueous emulsion wherein the silica particles are first compatibilized through reaction with a bifunctional coupling agent and then nano-sized through grinding, in another embodiment an emulsion process for making a silica-filled polymer masterbatch by dispersing and incorporating the hydrophobated silica nanoparticles into rubber latex, and in yet another embodiment a process useful for making polymer composites using the polymer-silica masterbatch.

Selection of Bifunctional Organosilane Coupling Agents

Elastomers, such as rubber, are not typically used in their pure form, but require reinforcement by fillers, which can help to fundamentally change the elastomers' physical and mechanical properties. Silica fillers, in their untreated/native forms, are gel particles with a high specific surface energy and may pose many problems when being used in manufacturing and processing elastomer composites, due, in part, to the very strong filler-filler interactions and not very strong interactions between the filler and the polymer. These difficulties can be overcome by the use of a bifunctional coupling agent, which chemically bonds to the filler during the mixing process and then to the polymer during vulcanization. Here, the mixing of silica fillers into the elastomer is fundamentally different from the mixing of carbon black compounds into the elastomer and the structures of the final silica-rubber composite products are fundamentally different from those of the carbon black reinforced rubber composites in that the elastomer (rubber) is linked chemically to the silica particles by covalent bonds, leading to a very strong silica-rubber network. In order to accomplish this, the very strong silica-silica agglomerates have to be first broken, the surfaces of the silica particles have to be then chemically modified via the reactions between the silica and one end of the bifunctional coupling agent, and finally, the silica-elastomer network has to be established in the curing step through reactions between the other end of the bifunctional coupling agent and the polymer network of rubber.

Nowadays, bifunctional organosilane-based coupling agents are widely available. Examples of bifunctional organosilane compounds that are useful as coupling agents used in this invention include, but are not limited to, those made by Evonik: Si 69®, Si 75®, Si 266®, VP Si 363®, KH-550, KH-560 or A-171. Preferably, the bifunctional organosilane coupling agent for practicing the present invention is Si 69®. One of the important features of these organosilane coupling agents is that they not only hydrophobating the silica effectively leading to their full incorporated into the resulting silica-filled rubber masterbatch, they also function, to some extent, as a rubber vulcanizing agent, activating agent and plasticizer, further increasing the extent of the crosslinking in the rubber masterbatch during vulcanization to improve the tensile strength, tear resistance and abrasion resistance of the masterbatch and reduce its permanent deformation. Furthermore, the proper use of a bifunctional organosilane coupling agent can lead to a desirable masterbatch composition meeting the specifications with improved Mooney viscosity (e.g., lower the Mooney viscosity of a high Mooney viscosity rubber) and with little silica loss in the subsequent steps. Such silica loss not only results in undesirable increases of raw material costs, but also calls for additional measures for disposing of the waste silica that is lost from the masterbatch and come out as fines in the process.

Process for Compatibilizing/Hydrophobtaining the Silica Nanoparticles in an Emulsion.

Silica (SiO₂) reinforcement filler useful for the present invention can include, among others, highly dispersible precipitated silicas, such as the HD Silica product line developed by Evonik. Such silicas, when used in combination with a bifunctional organosilane as the coupling agent, can meet the increasing demands for novel tread compounds in manufacturing high specification tires with low rolling resistance, good winter performance, long service life and excellent handling properties on wet and dry surfaces. Such silicas are essential to highly efficient mixing cycles and especially for achieving a very good abrasion resistance level. Precipitated silica is silica produced by precipitation from a solution containing silicate alkaline salts. The manufacturing of precipitated silica starts with the reaction of an alkaline silicate solution with a mineral acid in a chemical reactor. Typically, sulfuric acid and sodium silicate solutions are used. After adding both simultaneously with agitation to water, precipitation is carried out under alkaline conditions. The properties of the resultant silica depend on, among other conditions, agitation, duration of precipitation, the addition rate of reactants, their temperature and concentration, and the pH. The formation of a gel stage can be avoided by stirring at elevated temperatures. The resulting white precipitate is filtered, washed to remove the sodium sulfate byproduct and dried in the manufacturing process.

Precipitated Silica useful for the present invention is available as fine, loose powders or in granule form depending on the particular applications. The silica particles are amorphous with a chemical composition of approximately 99% SiO₂. Such silicas useful for the present invention have a BET surface area, as measured by nitrogen gas, in the range of about 30 to about 500 and preferably in the range of from about 50 to about 300 square meters per gram and their surface area (characterized by CTAB) in the range of from about 30 to about 500 and are preferably in a range of from about 50 to about 300 meters per gram using this test. Various commercially available silicas may be used in the practice of this invention, including, among others, Hi-Sil 190 and 233 from PPG Industries (One PPG Place, Pittsburgh, Pa., 15272 USA) and the line of products, such as ULTRASIL® 5000 and 7000, from Evonik (379 Interpace Parkway, Parsippany, N.J. 07054-0677 USA) or the ULTRASIL®5000GR and 7000GR (only commercially available in Asia, Harry-Kloepfer-Str. 1 50997, Köln, Germany). For instance, the highly dispersible ULTRASIL® 5000 GR used in the practice of this invention is of a low specific BET surface area (of approximately 115 m²/g) and a low CTAB surface area (of approximately 110 m²/g), and especially suited to high filler loadings for the optimization of wet and winter properties and excellent hysteresis performance. While the silica particles need to be hydrophobated (by reacting with a bifunctional organosilane coupling agent) first in order to be further bonded to the polymer network, pre-compatibilized silica, such as the Agilon® product line from PPG (e.g., Agilon® 400, which is the reaction product of a specific combination of mercaptoorganometallic and non-coupling agents as compatibilizers and silica with a specific surface area of 130 m²/g) and Coupsil® line from Evonik (e.g., Coupsil® 6508, which is the reaction product of organosilane DYNASILAN®VTEO [Vinyltriethoxysilan] and ULTRASIL® VN 2 silica with specific surface area of 125 m²/g), have become commercially available for various applications, including practicing present invention. Furthermore, organosilane coupling agents can be added during the silica manufacturing process at the so-called “water-glass” stage where an aqueous solution of soluble metal silicate is combined with acid to form a slurry of silica particles, followed by filtering, washing, de-watering and drying the resulting mixture under heat to initiate the reaction between the organosilane and silica to afford pre-functionalized silica that can also be used in, among other applications, practicing the present invention.

In one embodiment, the present invention provides a process for the preparation of compatibilized/hydrophobated silica before being used in the subsequent steps to make the rubber-silica masterbatch. The aforementioned silica from a commercial source was treated with a bifunctional organosilane coupling agent in a helical ribbon mixer/blender, which typically consists of a u-shaped horizontal mixing vessel with a double helical ribbon agitator rotating within. The feed (in this case, the silica followed by the organosilane) is charged into the mixer/blender from the top of the vessel through feeding devices mounted and located on the cover. The profile of the ribbons is such that during rotation, the external and internal ribbon flights cause movement of the materials in opposite directions (internal ribbons move materials toward the ends of the ribbon blender whereas the external ribbons move material back toward the center discharge of the ribbon blender), thereby resulting in a homogenous blending. Heating of the materials can also be achieved. At the end of the mixing cycle, the thoroughly mixed materials are discharged through one or more discharge valves located at the bottom most point of the vessel. Thus, the untreated silica is added to the mixer over about 30 minutes and heated to a temperature between 40 to 80° C. with agitation and proper ventilation. This is followed by the slow addition with agitation of an appropriate amount of a bifunctional organosilane coupling agent (such as Si 69®) to match the amount of silica being hydrophobated. Depending on the individual bifunctional organosilane and the surface areas of the silica, the amount of the coupling agent is in the range from 1% to 15%, preferably, from about 2% to about 10 wt %, and more preferably from about 4% to about 8 wt % of the organosilane relative to the silica. After the addition of organosilane is completed, the resulting mixture is heated to a temperature from 80 to 150° C., and more preferably from 95 to 130° C. and maintained at that temperature for about 2 to 5 hours and more preferably about 2.5 to 3.5 hours with agitation and thorough mixing. The heating is then stopped while the mixing continues for about another 30 min to ensure complete reaction.

In another embodiment, the present invention provides an alternative process for the preparation of compatibilized silica with a preferred ratio of about 4% to about 8 wt % of the organosilane relative to the silica by first preparing a 1:1 (w/w) mixture of the silica and the organosilane coupling agent and to this mixture is added additional amounts of the silica, which is calculated to achieve the final preferred ratio as mentioned above, followed by heating the said mixture to a temperature from 80 to 150° C., and more preferably from 95 to 130° C. and maintained at that temperature for about 2 to 5 hours and more preferably about 2.5 to 3.5 hours with agitation and thorough mixing. The heating is then stopped while the mixing continues for about another 30 min to ensure complete reaction.

In yet another embodiment, the present invention provides a process for the preparation of an emulsion of the compatibilized/hydrophobated silica nanoparticles. The particle sizes of the resultant compatibilized/hydrophobated silica prepared according to either of the aforementioned embodiments are mechanically reduced in a grinder together with a dispersing agent in an aqueous emulsion to nanometer scales, which ultimately results in a stable aqueous emulsion of said silica nanoparticles. The nanoscale particle size thus achieved is paramount to the successful practice of this invention leading to a highly stable emulsion of compatibilized silica nanoparticles highly uniformly dispersed and encapsulated therein. While not wishing to be bound by any particular theoretical explanation, it is believed that a combination of the significantly decreased particle sizes while increased particle surface areas, as a result of the grinding, and the inclusion of the dispersing agent lead to the formation of the desired stable emulsion, wherein the chances of forming aggregates of silica particles are similarly reduced. As compared to any other forms of slurries or solutions of compatibilized silicas prepared with methods/processes as previously disclosed by the others, the emulsion of compatibilized silica nanoparticles prepared according to the process provided by the current invention has the advantage of affording a more intimate mixing of the compatibilized silica particles with the rubber in latex form which could be carried out at room temperature without additional heating of the mixture, and thus leading to a highly uniform dispersion of the silica into the rubber latex with a significantly increased reaction efficiency between the bifunctional organosilane coupling agent and the rubber matrix and ultimately, the desired masterbatch structure of highly uniform incorporation of silica into the rubber network. In addition, the significantly increased efficiency for the incorporation of highly uniformly dispersed silica particles bonded with bifunctional organosilane coupling agent into the rubber matrix leads to more and stronger bondings between the coupling agent and the rubber polymer network while at the same time, significantly decreases the loss of silica during the subsequent steps of flocculation and co-precipitation with rubber.

Thus, the mixture of compatibilized silica particles prepared according to either of the aforementioned embodiments is introduced into a grinder followed by between about 2 to 10 times, and more preferably about 4 (four) times (w/w) the amount of water relative to the silica and appropriate amounts of a dispersing agent. Various dispersing agents can be employed to help de-aggregate the silica aggregates formed and uniformly disperse the silica nanoparticles in water leading to a highly stable aqueous emulsion of compatibilized silica that have high affinity for rubber matrix. The dispersing agents suitable for the current invention include, but not limited to, sodium lauryl ether sulfate and sodium dodecylbenzenesulfonates, and more preferably, it is dispersing gent NNO (sodium naphthalene-2-sulfonate formaldehyde (1:1:1), or Naphthalene sulfonate formaldehyde condensate), which is an anionic dispersing agent. It is soluble in water of any hardness, and has excellent diffusibility and ability to protective colloid formed. Typically, the amount of a dispersing agent used is in the range from about 0.1% to 12%, preferably, from about 2% to about 10 wt %, and more preferably from about 2% to about 8 wt % of the organosilane relative to the silica. The amount of NNO in practicing the present invention should be equal to about 5% o (w/w) of the silica particles.

For this embodiment of the present invention, a highly efficient mechanical grinding and dispersing equipment—a horizontal sand mill is selected. There are at least two general types of grinding devices: one using a grinding media and another without the use of any grinding media (which relies on mechanical forces solely for the grinding and dispersion actions). The devices using grinding media include, among others, sand mills and ball mills. The operation principle of a sand mill is simple while its production efficiency is reasonably high. Sand mills are further divided into vertical and horizontal types. The disadvantage of a vertical sand mill is the tendency for the grinding media to sink to its bottom, leading to difficulties in restarting the mill following temporary stops. Therefore, a horizontal sand mill is appropriate for the practice of this invention. The mixture of the compatibilized silica and other needed ingredients are introduced into the sand mill, which is operated at speed of about 2850 rev/min and the grinding time, which may need to be adjusted depending on the actual model of the grinder, is between about 0.1 to 10 hours, preferably between about 0.5 to 5 hours and more preferably, between about 0.2 to 1 hour. As discussed above, the size of the resulting silica nanoparticles highly uniformly dispersed in the aqueous emulsion is paramount to the successful practice of this invention. The size of the silica nanoparticles can be inferred by their settling rate. Large particles have a high settling rate, while small particles a smaller settling rate. The settling rate can be determined by the method which is more fully described in the Example section of this application to be between about 10 to 60 mg/h, preferably between about 10 to 40 mg/h and more preferably, to be below 30 mg/h and between about 10 to 25 mg/h. As a comparison, a wet process for preparing a silica-filled rubber masterbatch through reducing the size of the compatibilized silica nanoparticles with grinding to be about 80 mg/h was disclosed by Chinese Patent No. CN102153792 issued to Mai and co-workers. There is, however, no disclosure therein of the actual grinding device and the procedure/conditions used. Similarly, U.S. Pat. No. 7,312,271 issued to Chen and co-workers teaches several methods for making a solution masterbatch containing a diene elastomer in an organic solvent with a slurry of a reinforcing silica filler dispersed therein. The average particle size of the precipitated silica filler used was reduced to be substantially equivalent to an average particle size of a powdered silica by means of grinding, crushing, pulverizing, milling or the like. The silica particles were, directly or as a slurry, mixed with a diene elastomer in a first organic solvent, and the resulting mixture was desolventized to form a solution masterbatch preparation. While not wishing to be bound by any particular theoretical explanation, it is believed that it is of paramount importance for a preparation, as the one provided by this invention, of the desired stable emulsion with the compatibilized silica nanoparticles highly uniformly dispersed and encapsulated therein that the silica particle sizes be properly reduced such that the settling rate for the silica particles therein to be preferably between about 10 to 40 mg/h and more preferably, to be below 30 mg/h and between about 10 to 25 mg/h. The mixing of a stable emulsion of compatibilized silica particles that have been properly nano-sized in the emulsion with a polymer (such as rubber) in latex form can provide the desired highly uniform dispersion of the sillica nanoparticles in rubber and assure the kind of effective incorporation into the rubber polymer network that other methods cannot.

Process for Making Highly Uniformly Dispersed Silica-Filled Rubber Masterbatch

In still another embodiment of the present invention, a process is provided for incorporating the aqueous emulsion of compatibilized silica nanoparticles into a polymer in latex form in a wet or emulsion process. Natural rubber latex, and/or latex of synthetic rubber, such as styrene and butadiene monomers, are mixed together in water in a wet or emulsion process, and other needed additives including, among others, a modifier, an emulsifier and an activator are added to the solution to form a stock, which is stored in a storage tank and fed into a buffer tank. At the time of masterbatch manufacturing, the rubber latex is pumped first to a measuring tank, wherein an appropriate portion is measured out that is further fed into a reactor with stirring together with an initiator. Into this reactor is introduced, in a batch process via another pump, the emulsion of the compatibilized silica nanoparticles prepared according to the above-mentioned embodiment of this invention and the resulting mixture is allowed to mix further under ambient temperature until the compatibilized silica nanoparticles is adequately dispersed in the rubber latex.

Generally, the silica concentration in the rubber-silica masterbatch affects its dispersion therein. If the silica concentration is too high, the uniformity of its dispersion in the resulting masterbatch will be negatively impacted. If, on the other hand, the silica concentration is too low, the contact probability between the silica particles and the matrix of rubber hydrocarbons will be reduced and the flocculation process negatively impacted, leading to loss of unbonded silica particles. The optimal dispersed silica content in the rubber product should be controlled between about 15 phr to 150 phr (phr, parts per hundred parts of rubber), depending on the desired silica content in various products and more preferably, between about 20 to 120 phr. For practicing this invention, the proper rubber to silica ratio should be smaller than about 100/20 and preferably be between about 100/30 to about 100/100 and more preferably between about 100/30 to about 100/80.

As a result of blending of the rubber molecules in the latex, a polymer network is formed into which the silica nanoparticles are dispersed in a highly uniform fashion. The mild condition needed herein for an efficient mixing of the compatibilized silica nanoparticle emulsion with the rubber latex is a result of the high stability of the compatibilized silica emulsion, as demonstrated by the extremely low settling rate of the silica nanoparticles, and thus its high compatibility to the rubber latex. The product of the polymer-silica nanoparticle blending thus obtained exits out the bottom of the reactor and flows into a coagulation pool, wherein a coagulation agent is added simultaneously at high flow rate to effect vigorous mixing of the coagulant with polymer-silica nanoparticles blend by turbulent flows causing the latex to coagulate and form a gel-like solid immediately taking the shape of the pool. In principle, the coagulation process for an emulsion rubber should effectively precipitate the rubber out of the aqueous phase. Similarly, for the rubber-silica masterbatch according to the present invention, the coagulation process should effectively co-precipitate out both the rubber and the silica that is highly uniformly distributed in the rubber polymer network from the aqueous phase. The more effective the coagulating agent, the less rubber and silica are left in the aqueous phase after coagulation. An ineffective coagulating agent will cause significant amounts of silica fines left out in the aqueous, which is undesirable.

The aforementioned mixture can be coagulated using conventional coagulation agents. Coagulating agents useful in the present invention include sulfuric and hydrochloric acid, acetic acid, formic acid, sodium chloride and aluminum sulfate. The selection of the type and amount of the coagulation agent for different applications depend on various factors. For the process provided by the present invention, the particular coagulation agent has to be able to effectively coagulate the rubber polymer network formed in the blending of NR latex and/or a SBR latex, within which the nanoparticles of compatibilized silica are highly uniformly dispersed and incorporated via common hydrophobicity.

Coagulation with an acid, mainly acetic acid, formic acid, and sulfuric acid, as the coagulation agent is currently the most widely used method of coagulating natural rubber latexes, which also is the first coagulation method used worldwide for processing raw rubber. The mechanism of action for acid coagulating rubber latex is believed to be the following: rubber latex is a suspension in an aqueous medium of microscopic natural rubber particles, which consist of a protein membrane enclosing the rubber polymers. The surfaces of the latex particles are therefore negatively charged, resulting in forces of repulsion between them that keep them from coagulating. In the coagulation process, the acid containing positively charged protons neutralizes these charges, thereby eliminating the forces of repulsion between the rubber particles. The collision of the freed rubber polymer molecules joins them into longer polymer chains and more and more complex networks and ultimately continuous aggregation and solidification into solid blocks.

In the early years, coagulation mainly with sulfuric acid was used in rubber factories in Malaysia for rubber manufacturing. However, it was later discovered that under certain pH conditions, coagulating rubber latex with sulfuric acid resulted in raw rubber with its Mooney viscosity that could further decrease, while those coagulated with formic acid would not. Additionally, the decrease of the plasticity retention rate of the rubber coagulated with sulfuric acid was more significant than that with formic acid, while the resistance to aging of the raw rubber coagulated with sulfuric acid were also found to be inferior. Therefore, formic acid is generally the preferred choice since it is cost-efficient and guarantees a consistent high-quality natural rubber product.

The strength of formic acid is ideal for transforming latex into homogeneous dry rubber with consistent physical and chemical properties. The use of stronger acids makes the pH drop too fast and inhomogeneously. As a result, the latex coagulates unevenly, which may affect its mechanical properties. Weaker acids, such as acetic acid, are less efficient than formic acid in coagulation and thus result in much higher acid consumption. For instance, acetic acid may also be used as a coagulating agent, but it has gradually been replaced by formic acid, as a result of the higher cost for acetic acid, and a poor yield of rubber solids and longer coagulation time when using acetic acid as the coagulant. Furthermore, formic acid has low toxicity and low corrosiveness to equipment and the dry natural rubber solids made with formic acid as the coagulant have higher thermal stability during storage and better vulcanization characteristics.

Therefore, in another embodiment of the present invention of a wet manufacturing process for the natural rubber-silica masterbatch, the preferred coagulating agent provided is formic acid (5%). The amount of such coagulating agent added to the emulsion provides a concentration in the latex of less than about 5 wt %, preferably less than about 2.5 wt %, more preferably less than about 1.0 wt %, and most preferably between about 0.2 and about 0.8 wt %.

Upon adding the coagulating agent, a sheet of gel-like product is formed in the coagulation pool taking the shape of the pool. During the process as the latex coagulates to form rubber, silica nanoparticles are incorporated into the rubber polymer network in a highly uniformly dispersed form. As a result, all of the essential components of the desired polymer-silica masterbatch coprecipitate out of the aqueous phase together without any significant loss. The gel-like rubber-silica product went through several tanks for washing as well as a neutralizing tank to remove the remaining acidic impurities. The resulting product is then dewatered, and subsequently dried in an oven into the desired final product, the rubber-silica masterbatch made according to the present invention, which is a natural and/or synthetic rubber product containing within its polymer networks highly uniformly dispersed silica particles in nano-scales. To maximize the versatility of the rubber-silica masterbatch prepared according to the present invention and the flexibility of its subsequent use, the level of contained silica in the rubber-silica masterbatch should be as high as the subsequent process equipment can handle.

There are no particular limitations as to the polymers that can be used in this invention, which can be any rubber, elastomer or polymer and can also be blends of rubbers, such as those of natural and synthetic rubbers. The polymer is preferably selected from the group consisting of polyisoprene rubber, styrene-butadiene rubber, natural rubber, acrylonitrile butadiene rubber, polychloroprene rubber, polybutadiene rubber, vinyl pyridine butadiene rubber and ethylene propylene diene monomer rubber. There are other optional ingredients that can be used with the silica and latex for the present invention, which include such materials as processing oils, other fillers such as carbon black, talc or clay, stabilizers or other antidegradants, zinc salts, waxes, resins, or crosslinking chemicals. In addition, any material necessary for further compounding, which does not interfere with the coagulation and other downstream processes, can be included.

Process for Making Rubber Composite Products

The rubber-silica masterbatch produced according to the present invention can be used to make a variety of rubber composite products, such as hoses, tubing, gaskets, automobile parts and cable sheaths, and in particular, automobile tires. The rubber-silica masterbatch prepared according to the present invention can significantly improve the tire manufacturing process. As mentioned above, natural rubber and Silica are incompatible with each other due to the difference in their polarity. Because of this, the silica particles tend to agglomerate in natural rubber, not easily dispersed in natural rubber compound during mixing. Furthermore, the addition of silane coupling agent for bonding silica to rubber requires mixing to high temperature and multiple passes of mixing in the mixer. There are also environmental issues associated with mixing silica and silane by the dry method such as dust caused by fines in silica particles and the emission of ethanol during mixing when silane is reacting with silica. Silica is an abrasive material; therefore, it can cause excessive wear and tear on mixing equipment requiring the frequent rebuilding of the body and rotors of the mixer. When the natural rubber and silica are mixed in low viscosity liquid phase as describe in the present invention, the silica nanoparticles can be dispersed in the rubber matrix uniformly and the rubber and silica can be mixed in almost any ratio while still retaining, through covalent bonds, silica nanoparticles in the rubber polymer network. The process provided by the present invention also enables the use of difficult to incorporate materials by dry mixing, such as high structure silica. Because the silica is pre-reacted with organosilane coupling agent, there is no need to mix the rubber compounds under harsh conditions, such as to high temperatures, which requires longer mixing time and higher cooling capacity in downstream operations resulting in reduced throughp in the mixing operation. The rubber compounds can be mixed either in high-shear internal mixers or simply on the low-shear two-roll mills. The process provided by the present invention further provides multiple benefits to the natural rubber-silica masterbatch customers: reduced number of mixing passes, more throughput, lower energy cost during mixing, improved physical and mechanical properties of the rubber compounds due to the improved dispersion of the silica in the rubber matrix, cleaner plant with no handling of loose silica, longer mixing equipment life due to less wear and tear resulting in less maintenance costs, and higher productivity because of improved compound consistency and less scrap.

### Examples

### Materials:

1) High-quality natural rubber (refers to natural rubber latex with the impurities removed and up to 60% in concentration) or blend of high-quality natural rubber and synthetic rubber (styrene butadiene rubber latex or other emulsified synthetic rubber latex);

2) Amorphous silica (SiO₂*nH₂O, prepared by the precipitation method), such as Ultrasil 5000 GR (Evonik Industries AG) with its SiO₂ content of 87%˜95%, whiteness of 95% and an average particle size of 11˜100 nm, specific surface area of 45˜380 m²/g, oil absorption (DBP) value of 1.6˜2.4 cm³/g, relative density of 1.93 to 2.05, and water content of 4.0% to 8.0%;

3) Bifunctional organosilane coupling agent, such as Si 69® (Evonik Industries AG), an bifunctional, sulfur-containing organosilane that reacts with silanol groups of silica during mixing and with the polymer during vulcanization under formation of convalent chemical bonds for the specific purpose of improving the performance of the resulting composite materials.

### Example 1: Preparation of SMB with Nanosized and Compatibilized Silica (30 Phr)

A. Preparation of Compatibilized Silica

The surface of silica of very fine particle size was first chemically modified to enhance its hydrophobicity and improve the compatibility with the rubber latex. Thus, silica from commercial sources (such as Ultrasil 5000 GR) was added to a mixer, wherein it was heated with stirring and proper ventilation to 60° C., followed by an appropriate amount of a bifunctional organosilane coupling agent (such as Si 69®) added slowly with stirring. The selection of the proper type and amount of the coupling agent is discussed in the Detailed Description section. Upon completing the addition of the coupling agent, the resulting mixture was heated to 100-120° C. and maintained at that temperature for 3 hours with the stirring continued. The heating was then stopped while the mixing continued for another 30 min. The total sulfur content of the compatibilized silica was measured to be about 2.0%.

B. Formation of Silica Emulsion

The particle sizes of the resulting chemically modified (compatibilized) silica were reduced to nano-scales in a sand mill into an aqueous emulsion. Thus, 110 g of the compatibilized silica obtained in A) is poured into a horizontal sand mill, Model CWS-100 (by Changzhou Yingzhi Machinery Co. China), followed by 440 g, i.e., 4 (four) times the mount (w/w), of deionized water and 0.55 g of a dispersing gent, NNO (sodium naphthalene-2-sulfonate formaldehyde (1:1:1), or Naphthalene sulfonate formaldehyde condensate). The resulting mixture was ground by the sand mill operated at speed of 2850 rev/min and the grinding time was 20 min to result in an emulsion of compatibilized silica nanoparticles. The silica emulsion stock thus obtained was stored in a container with constant stirring ready for the next step. An aliquot of the said emulsion was used to formulate to a specific concentration (20% by weight) to measure its settling rate, which was found to be ≦30 mg/h. The uniformly dispersed fine particles of silica in the silica emulsion obtained herein would aid its uniform dispersion in the rubber latex to avoid the loss of silica during flocculation and co-precipitation with rubber.

C. Removal of Impurities in the Fresh Natural Rubber

The solid impurities, protein, sugar, resin, and metals such as calcium and magnesium are removed by chemical and mechanical methods. The solid rubber content of the high-quality natural rubber latex thus obtained is about 30 to 70% and more preferably, about 60%. Thus, to 556 g of the resulting high purity rubber latex (solid rubber content=60%) was added 556 g of deionized water and the latex mixture was thoroughly stirred.

D. Preparation of Silica Masterbatch

i. The emulsified silica-water mixture is fed into the aforementioned natural rubber latex (or a mixture of natural rubber and styrene-butadiene rubber latex), and mixed with stirring, while adding oil (low PAH aromatic oil, paraffinic oil, naphthenic oil or vegetable oil) or other rubber compounding ingredients such as anti-oxidant or anti-ozonant. The purpose of adding the oil to the rubber is to improve the processability of the masterbatch for re-processing.

ii. The mixing time is 30-45 minutes at a temperature of 25-45 degrees C., stirring speed of 25-80 rpm, silica and rubber ratio of (30-90):100, the content of oil in the rubber (10-30 PHR), the natural rubber and styrene-butadiene rubber ratio of (70-50):(30-50). The choice of acid for flocculation and co-precipitation is formic acid with a concentration of about 3 to 9.5 wt. % and more preferably about 5%. The flocculation and co-precipitation speed is controlled to be less than 10 minutes. The flocculation is conducted in a long trough where the well-mixed rubber-silica latex mixture is fed into the trough concurrently with the acid continuously at one end of the trough and the precipitated solid is carried manually or by a conveyor to the other end of the trough for down-stream repeated washing/pressing (in a series of WMB Washing Machines with tap water) and neutralizing (in a neutralizing tank) until it became neutral.

iii. The resulting precipitated rubber—silica masterbatch is finally de-watered by pressing. The NR-silica materbatch is then pelletized into pellets smaller than 1 mm³ and dried at 120° C. for 5 hours. Optionally, the pellets can be dried continuously on a perforated conveyor in a hot air oven.

### Example 2: Preparation of SMB with Nanosized and Compatibilized Silica (50 Phr)

The SMB is prepared with a procedure very similar to that in Example 1, except by using 183.8 g of the compatibilized silica, 735 g of deionized water and 0.92 g of the dispersing gent, NNO.

### Example 3: Preparation of SMB with Nanosized and Compatibilized Silica (60 Phr)

The SMB is prepared with a procedure very similar to that in Example 1, except by using 220 g of the compatibilized silica, 880 g of deionized water and 1.10 g of the dispersing gent, NNO.

### Comparative Example 1: Preparation of SMB with Non-Nanosized Silica (30 Phr)

The SMB is prepared with a procedure similar to that in Example 1, except by avoiding Step B.

### Comparative Example 2: Preparation of SMB with Non-Nanosized Silica (50 Phr)

The SMB is prepared with a procedure similar to that in Example 2, except by avoiding Step B.

### Comparative Example 3: Preparation of SMB with Non-Nanosized Silica (60 Phr)

The SMB is prepared with a procedure similar to that in Example 3, except by avoiding Step B.

TABLE 1
Ash Content of the
Masterbatches

| | | Masterbatch Prepared in Example | | | | | |
|---|---|---|---|---|---|---|---|
| Wet Silica Masterbatch | | 1 | 2 | 3 | C-1 | C-2 | C-3 |
| Composition | Natural | 100 | 100 | 100 | 100 | 100 | 100 |
| of NR/Silica | Rubber | | | | | | |
| Wet | Silica | 30 | 50 | 60 | 30 | 50 | 60 |
| Materbatch | Si 69 ® | 3 | 5 | 6 | 3 | 5 | 6 |
| Settling Rate of | | 20 mg/h | 21 mg/h | 20 mg/h | 70 g/h | 80 g/h | 74 g/h |
| Silica Particles | | | | | | | |
| Ash Content | Test 1 (%) | 22.31 | 32.13 | 36.07 | 19.89 | 30.05 | 33.89 |
| in NR/Silica Wet | Test 2 (%) | 22.28 | 32.09 | 36.09 | 20.68 | 29.56 | 34.75 |
| Masterbatch | | | | | | | |

Note:
1) Ash (Silica) Content is determined by a fast ash method (ASTM-D1603) through burning a specimen of dried NR/Silica masterbatch in a crucible in a muffle furnace at 800° C. for 6 minutes under air;
2) A typical method for determining the settling rate of silica particles is as the following: A aliquot (approx. 2 g) of the silica emulsion with a concentration of C, is placed in a graduated glass tube with a stopper in scales of 100 ml (accurate to 0.1 ml), followed by deionized water to reach a total volume of 100 ml. The stopper is closed and the tube thoroughly shaken before being let stand on a flat surface for 20 minutes. The volume of the resulting supernatant is read as V (ml) and the settling rate (X) is calculated as: X (mg/h) = V * (m * C/100) * 3 * 1000 wherein, m: sample mass, g; V: volume of supernatant, ml; C: concentration of silica emulsion, % (W/W)

It can be clearly seen from the above results that in each materbatch prepared with nanosized silica, the silica content is higher while the settling rate significantly lower than the corresponding results in the Comparative Examples prepared with non-nanosized silica (without the grinding step).

TABLE 2
Content of the Masterbatchs

| | | Masterbatch Prepared in Example | | | | | |
|---|---|---|---|---|---|---|---|
| Wet Silica Masterbatch | | 1 | 2 | 3 | C-1 | C-2 | C-3 |
| Composition | Natural | 100 | 100 | 100 | 100 | 100 | 100 |
| of NR/Silica | Rubber | | | | | | |
| Wet | Silica | 30 | 50 | 60 | 30 | 50 | 60 |
| Masterbatch | Si 69 ® | 3 | 5 | 6 | 3 | 5 | 6 |
| Compounding | Zinc Oxide | 5 | 5 | 5 | 5 | 5 | 5 |
| Ingredients | Stearic Acid | 1.5 | 1.5 | 1.5 | 1.5 | 1.5 | 1.5 |
| (PHR) | Antioxidant | 2 | 2 | 2 | 2 | 2 | 2 |
| | 6 PPD | | | | | | |
| | Accelerator | 1.5 | 1.5 | 1.5 | 1.5 | 1.5 | 1.5 |
| | TBBS | | | | | | |
| | Accelerator | 1 | 1 | 1 | 1 | 1 | 1 |
| | DPG | | | | | | |
| | Sulfur | 1.5 | 1.5 | 1.5 | 1.5 | 1.5 | 1.5 |

The mixed rubber compounds were vulcanized at 145° C. for 20 minutes to form test specimens.

TABLE 3
Results of Testing Specimens obtained by vulcanizing (at 145° C. for 20 minutes)
the masterbatchs prepared in Example 1-3 and Comparative Examples 1-3, contents
shown in Table 2

| | | Masterbatch Prepared in Example | | | | | |
|---|---|---|---|---|---|---|---|
| | | 1 | 2 | 3 | C-1 | C-2 | C-3 |
| Tensile Strength (MPa) | | 32 | 28 | 27 | 26 | 23 | 21 |
| Elongation at Break (%) | | 628 | 560 | 523 | 580 | 515 | 490 |
| 100% Modulus (MPa) | | 1.6 | 1.9 | 2.6 | 0.6 | 0.9 | 1.1 |
| 300% Modulus (MPa) | | 6.5 | 13.2 | 14.4 | 3.8 | 6.6 | 7.1 |
| Reinforcing Index (300% | | 4.1 | 6.9 | 5.5 | 6.9 | 7.3 | 6.4 |
| M/100% M) | | | | | | | |
| Shore A Hardness | | 46 | 67 | 71 | 42 | 61 | 66 |
| Akron Abrasion (g/cm³) | | 0.22 | 0.24 | 0.25 | 0.28 | 0.31 | 0.33 |
| Tear Strength (N/mm) | | 85 | 93 | 98 | 76 | 82 | 85 |
| Tangent Delta (60° C.) | | 0.12 | 0.15 | 0.17 | 0.14 | 0.18 | 0.2 |
| Heat Aging | Retained | 85 | 88 | 90 | 82 | 84 | 85 |
| Resistance (Aged 48 | Tensile | | | | | | |
| hours in Hot Air | Strength % | | | | | | |
| Oven at 100° C.) | Retained | 83 | 85 | 88 | 79 | 82 | 83 |
| | Elongation at | | | | | | |
| | Break % | | | | | | |
| | Retained | 86 | 88 | 89 | 80 | 83 | 84 |
| | 100% | | | | | | |
| | Modulus % | | | | | | |
| | Retained | 85 | 87 | 90 | 78 | 80 | 81 |
| | 300% | | | | | | |
| | Modulus % | | | | | | |
| | Change in | −2 | −1 | 1 | −3 | −1 | −1 |
| | Shore A | | | | | | |
| | Hardness | | | | | | |

The above test results show that the masterbatchs prepared with highly uniformly dispersed compatibilized silica nanoparticles (through grinding), as compared to those prepared with non-nanosized silica (without grinding), showed very significant and remarkable increases in tensile strength, 300% modulus, tear strength, and abrasion resistance, as a result of both better dispersion of the silica nanoparticles and their better integration.

### Example 4: Preparation of SMB with Nanosized and Compatibilized Silica and a Blending of Natural and Synthetic Rubber (NR/SBR/SiO2=70:30:30 Phr)

The SMB is prepared with a procedure similar to that in Example 1, except in Step C, a blend of natural and styrene-butadiene latex (ESBR1502) is used instead of natural rubber latex to achieve NR/SBR/SiO2=70:30:30. Thus, 388.9 g of natural rubber latex (concentrated by centrifugation to 60% of dry rubber content) and 388.9 g of deionized water are mixed with stirring, followed by 500.0 g of 20% styrene-butadiene latex and the resulting mixture is stirred thoroughly before the compatibilized silica emulsion prepared in Step A is added.

### Example 5: Preparation of SMB with Nanosized and Compatibilized Silica and a Blending of Natural and Synthetic Rubber (NR/SBR/SiO2=70:30:50 Phr)

The SMB is prepared with a procedure similar to that in Example 2, except in Step C, a blend of natural and styrene-butadiene latex (ESBR1502) is used instead of natural rubber latex to achieve NR/SBR/SiO2=70:30:30. Thus, 388.9 g of natural rubber latex (concentrated by centrifugation to 60% of dry rubber content) and 388.9 g of deionized water are mixed with stirring, followed by 500.0 g of 20% styrene-butadiene latex and the resulting mixture is stirred thoroughly before the compatibilized silica emulsion prepared in Step A is added.

### Example 6: Preparation of SMB with Nanosized and Compatibilized Silica and a Blending of Natural and Synthetic Rubber (NR/SBR/SiO2=30:70:30 Phr)

The SMB is prepared with a procedure similar to that in Example 1, except in Step C, a blend of natural and styrene-butadiene latex (ESBR1502) is used instead of natural rubber latex to achieve NR/SBR/SiO2=70:30:30. Thus, 166.7 g of natural rubber latex (concentrated by centrifugation to 60% of dry rubber content) and 166.7 g of deionized water are mixed with stirring, followed by 1166.7 g of 20% styrene-butadiene latex and the resulting mixture is stirred thoroughly before the compatibilized silica emulsion prepared in Step A is added.

### Example 7: Preparation of SMB with Nanosized and Compatibilized Silica and a Blending of Natural and Synthetic Rubber (NR/SBR/SiO2=30:70:50 Phr)

The SMB is prepared with a procedure similar to that in Example 2, except in Step C, a blend of natural and styrene-butadiene latex (ESBR1502) is used instead of natural rubber latex to achieve NR/SBR/SiO2=70:30:30. Thus, 166.7 g of natural rubber latex (concentrated by centrifugation to 60% of dry rubber content) and 166.7 g of deionized water are mixed with stirring, followed by 1166.7 g of 20% styrene-butadiene latex and the resulting mixture is stirred thoroughly before the compatibilized silica emulsion prepared in Step A is added.

TABLE 3
Results of Testing Specimens obtained by vulcanizing (at 145°
C. for 20 minutes) the masterbatchs prepared in Example 4-7

| | Examples | | | |
|---|---|---|---|---|
| | 4 | 5 | 6 | 7 |
| NR/ESBR/Silica | 70/30/30 | 70/30/50 | 30/70/30 | 30/70/50 |
| tc10, minutes* | 8.08 | 11.50 | 13.32 | 16.95 |
| tc90, minutes* | 15.48 | 22.07 | 27.68 | 32.88 |
| Tensile Strength (MPa) | 23.4 | 24.6 | 12.7 | 20.5 |
| Elongation at Break (%) | 602 | 596 | 503 | 483 |
| 100% Modulus (MPa) | 1.32 | 1.59 | 1.28 | 1.51 |
| 300% Modulus (MPa) | 5.35 | 7.78 | 5.16 | 6.86 |
| Shore A Hardness | 47 | 56 | 50 | 55 |
| Tear Strength (N/mm) | 62.13 | 69.88 | 59.64 | 66.59 |

*Moving Die Rheometer, 145° C.

### Example 8 Comparison of Various Coupling Agents for Preparation of Silica Masterbatch

The characteristics of silica modified natural rubber products prepared with four organosilane coupling agents, -aminopropyltriethoxysilane (KH-550), -glycidoxypropyltrimethoxysilane (KH-560), Si 69® and vinyl trimethoxysilane (A-171) are compared. The results are listed below in Table 5 and Table 6.

Table 5 shows that the samples using coupling agent KH-550 have the highest Mooney viscosity values while those with Si 69® the lowest. The samples using coupling agent KH 560 had poor scorch safety performance while those with Si 69® showed excellent scorch safety performance. Also, the results in Table 5 showed that the vulcanized rubber composite products containing silica nanoparticles compatibilized with Si 69®, relative to other coupling agents, demonstrated the most remarkable increases in tensile strength, 300% modulus, tear strength, and abrasion resistance, as a result of both better dispersion of the silica nanoparticles and their better integration, via bonding through the coupling agent, into the rubber molecular network.

TABLE 5
Effects of Different Coupling Agents on Compound Mooney Viscosity
and Vulcanization Characteristics (NR:Silica - 100:30)

| | |
|---|---|
| Tested | Coupling Agents |

| parameters | KH-550 | KH - 560 | Si 69 ® | A - 171 |
|---|---|---|---|---|
| ML (1 + 4 | 78 | 74 | 68 | 70 |
| @100° C.) | | | | |
| tc10, minutes* | 4.68 | 3.31 | 5.88 | 5.42 |
| Tc90, minutes* | 11.85 | 10.68 | 11.33 | 12.13 |
| ML, dN · m* | 0.61 | 0.71 | 0.69 | 0.47 |
| MH, dN · m* | 14.22 | 15.05 | 14.8 | 13.63 |

*Moving Die Rheometer, 145° C.

TABLE 6
Effects of Different Coupling Agents on Physical and Mechanical
Properties of Vulcanizates (NR:Silica - 100:30)

| | |
|---|---|
| Tested | Coupling Agents |

| parameters | KH-550 | KH - 560 | Si 69 ® | A - 171 |
|---|---|---|---|---|
| Tensile Strength | 28.6 | 29.1 | 29.4 | 26.4 |
| (MPa) | | | | |
| Tear Strength | 53.6 | 67.5 | 69.5 | 50.7 |
| (N/mm) | | | | |
| 300% Modulus | 5.8 | 7.1 | 7.3 | 6.3 |
| (MPa) | | | | |
| Elongation at | 657 | 580 | 621 | 803 |
| Break (%) | | | | |

The entire disclosure of every patent and non-patent publication cited in the foregoing specification is incorporated by reference herein.

While certain embodiments of the present invention have been described and/or exemplified above, various other embodiments will be apparent to those skilled in the art from the foregoing disclosure. The present invention is, therefore, not limited to the particular embodiments described and/or exemplified, but is capable of considerable variation and modification without departure from the scope of the appended claims.

Furthermore, the transitional terms “comprising”, “consisting essentially of” and “consisting of”, when used in the appended claims, in original and amended form, define the claim scope with respect to what unrecited additional claim elements or steps, if any, are excluded from the scope of the claim(s). The term “comprising” is intended to be inclusive or open-ended and does not exclude any additional, unrecited element, method, step or material. The term “consisting of” excludes any element, step or material other than those specified in the claim and, in the latter instance, impurities ordinary associated with the specified material(s). The term “consisting essentially of” limits the scope of a claim to the specified elements, steps or material(s) and those that do not materially affect the basic and novel characteristic(s) of the claimed invention.

What is claimed is:

1. A polymer silica masterbatch comprising:
a) a latex of a natural or a synthetic polymer or combinations thereof;
b) an aqueous emulsion of about 10 weight percent to about 60 weight percent of a silica that is compatibilized with about 1 weight percent to about 15 weight percent of one or more organosilane coupling agents chemically bound to the surface of the silica, where the chemically modified silica particles are mechanically nano-sized through grinding in the emulsion which is further stabilized by a dispersing agent; and
c) one or more compounding ingredients or combinations thereof.

2. The polymer silica masterbatch of claim 1, wherein the organosilane coupling agent is selected from mercaptopropyl-trimethoxysilane, bis-(3-trimethoxysilylpropyl)-disulfide, bis-(3-trimethoxysilylpropyl)-tetrasulfide, γ-aminopropyltriethoxysilane, γ-glycidoxypropyltrimethoxy-silane, and vinyl trimethoxysilane or combinations thereof.

3. The polymer silica masterbatch of claim 1, wherein the dispersing agent is selected from sodium lauryl ether sulfate, sodium dodecylbenzenesulfonates, NNO (sodium naphthalene-2-sulfonate formaldehyde (1:1:1) or combinations thereof.

4. The polymer silica masterbatch of claim 1, wherein the natural or synthetic polymer is a latex form of a natural rubber or a synthetic rubber or a thermoplastic polymer or a resin polymer, or combinations thereof.

5. The polymer silica masterbatch of claim 4, wherein the natural rubber is Hevea or guayule.

6. The polymer silica masterbatch of claim 4, wherein the natural or synthetic polymer is a polymer selected from the group consisting of: a polymer of a conjugated diene, a vinyl monomer and combinations thereof.

7. The polymer silica masterbatch of claim 4, wherein the synthetic polymer is from the group consisting of: polyisoprene rubber, styrene-butadiene rubber, acrylonitrile-butadiene rubber, polyvinylchloride, acrylonitrile-butadiene-styrene polymer, carboxylated styrene butadiene, carboxylated acrylonitrile-butadiene, styrene-acrylonitrile copolymer, polybutadiene, polyisoprene, polychloroprene, ethylene propylene diene monomer rubber, polybutadiene-isoprene, or mixtures thereof.

8. The polymer silica masterbatch of claim 1, further comprising from 0.05 weight percent to 30 weight percent based on the final rubber formulation of a member of compouding ingredients in the group comprising: extender oils, colorants, pigments, antistatic additives, antioxidants, stabilizers, other fillers and combinations thereof.

9. A process for the preparation of the polymer silica masterbatch according to claim 1, said process comprising the steps of:
(a) compatibilizing silica by (i) forming a mixture of fine silica particles and an organosilane coupling agent at a desired silica to silane ratio wherein the coupling agent has the capability of chemically reacting with the surface of the silica to bond the coupling agent to the silica, and wherein the coupling agent has the capability of bonding to rubber during vulcanization of the rubber, and (ii) heating the said mixture to a temperature at a range of 60° C.-200° C. while it is being stirred in a mixer rotating at a speed range of 20-80 revolution/min and maintaining the heating and stirring for a time range of 0.1-10 hr; and
(b) making an aqueous emulsion of the compatibilized silica nanoparticles by adding water [the amount of which is from about 1 to about 10 times based on the weight of the compatibilized silica obtained in (a)] and subjecting the resultant aqueous mixture to grinding in the presence of an dispensing agent with a grinding device operated at a speed range of 2500-3100 revolution/min for a time range of 0.1-5 hours such that the extent of the size reduction and dispersion of the silica nanoparticles and stability of the resulting emulsion as related to the rate of settling of the silica nanoparticles is, optimally between a range of 10-40 mg/h and more preferably, is below 30 mg/h and further between a range of 10-25 mg/h, as measured in a separate suspension formulated by taking an aliquot of the resulting emulsion and diluting the aliquot in water;
(c) making a polymer latex and admixing the compatibilized silica emulsion obtained in step (b) with the polymer latex;
(d) coagulating the silica-polymer latex formed in step (c) in a trough or pool to form a gel-like soft solid in the shape of the trough/pool with very little loss of silica in the process;
(e) dewatering the coagulated said soft solid; and
(f) drying the dewatered solid.

10. A process for the preparation of the polymer silica masterbatch according to claim 1, said process comprising the steps of:
(a) compatibilizing silica by (i) admixing fine silica to a pre-blended 1:1 (w/w) mixture of silica and an organosilane coupling agent to achieve a desired silica to silane ratio wherein the coupling agent has the capability of chemically reacting with the surface of the silica to bond the coupling agent to the silica, and wherein the coupling agent has the capability of bonding to rubber during vulcanization of the rubber, and (ii) heating the said mixture to a temperature at a range of 60° C.-200° C. while it is being stirred in a mixer rotating at a speed range of 20-80 revolution/min and maintaining the heating and stirring for a time range of 0.1-10 hr; and
(b) making an aqueous emulsion of the compatibilized silica nanoparticles by adding water [the amount of which is from about 1 to about 10 times based on the weight of the compatibilized silica obtained in (a)] and subjecting the resultant aqueous mixture to grinding in the presence of an dispensing agent with a grinding device operated at a speed range of 2500-3100 revolution/min for a time range of 0.1-5 hours such that the extent of the size reduction and dispersion of the silica nanoparticles and stability of the resulting emulsion as related to the rate of settling of the silica nanoparticles is, optimally between a range of 10-40 mg/h and more preferably, is below 30 mg/h and further between a range of 10-25 mg/h, as measured in a separate suspension formulated by taking an aliquot of the resulting emulsion and diluting the aliquot in water;
(c) making a polymer latex and admixing the compatibilized silica emulsion obtained in step (b) with the polymer latex;
(d) coagulating the silica-polymer latex formed in step (c) in a trough or pool to form a gel-like soft solid in the shape of the trough/pool with very little loss of silica in the process;
(e) dewatering the coagulated said soft solid; and
(f) drying the dewatered solid.

11. A process according to claim 9 to prepare the polymer silica masterbatch of claim 1, wherein the concentration of the silica in the nano-sized and compatibilized silica emulsion is between about 15% and about 24% by weight.

12. A process according to claim 9 to prepare the polymer silica masterbatch of claim 1, wherein the organosilane coupling agent used is selected from γ-aminopropyltriethoxysilane, γ-glycidoxy-propyltrimethoxysilane, bis[3-(triethoxysilyl)propyl]tetrasulfide and vinyl trimethoxysilane, and is more preferably bis[3-(triethoxysilyl)propyl]tetrasulfide and its amount used is between about 1% and about 15% by weight relative to the silica.

13. A process according to claim 9, wherein the dispersing agent used is sodium lauryl ether sulfate or sodium dodecylbenzenesulfonates or NNO (sodium naphthalene-2-sulfonate formaldehyde (1:1:1), and more preferably NNO (sodium naphthalene-2-sulfonate formaldehyde (1:1:1), and its amount used is between about 3% and about 8% by weight relative to the silica.

14. A process according to claim 9, wherein the coagulating agent used is sulfuric acid or acetic acid or formic acid, and more preferably formic acid, and its amount used is between about 3% and about 6% by weight relative to the silica.

15. A process according to claim 9, wherein for the step (a) of compatibilizing the silica particles, heating the said mixture to a temperature at a range of 80° C.-150° C. while it is being stirred in a mixer rotating at a speed range of 30-60 revolution/min and maintaining the heating and stirring for a time range of 1-5 hr.

16. A process according to claim 9 to prepare the polymer silica masterbatch of claim 1, wherein the step (a) of compatibilizing the silica particles is omitted and the compatibilized silica used in the step (b) of forming the emulsion of silica nanoparticles is silica pre-treated or pre-functionalized with a bifunctional organosilane.

17. A process according to claim 9, wherein for the step (b) of forming the emulsion of silica nanoparticles, the additional water used is between about 3 times to about 5 times by weight relative to the silica, the grinding machine is operated at a speed range of 2750-2950 revolution/min and the range of the grinding time is between about 0.2 to about 1 hour.

18. A process according to claim 9, further comprising, in the step of mixing the silica emulsion with the polymer latex (c), admixing one or more ingredients into the resulting polymer latex mixture selected from the group consisting of processing oils, carbon black, talc, clay, stabilizer, antidegradants, zinc salts, waxes and resins.

19. A process according to claim 9, further comprising recovering the dried solid of polymer-silica masterbatch, wherein the polymer latex contains an amount of dry polymer, wherein the weight ratio of the amount of dry polymer to silica is within the range of 100/15 and 100/150, and wherein the solid content of the silica masterbatch is greater than about 20%

20. A process according to claim 19, further comprising admixing the silica masterbatch with a rubber composition to make a silica-filled rubber composition; and forming an article of manufacture from the silica-filled rubber composition.

21. A process according to claim 20, wherein the article of manufacture comprises tread for a tire, anti-vibration and support parts, sleeves and belts for automobile and mechanical uses, flooring tiles and floor supports, shoe soles and sporting goods.

22. A process according to claim 10 to prepare the polymer silica masterbatch of claim 1, wherein the concentration of the silica in the nano-sized and compatibilized silica emulsion is between about 15% and about 24% by weight.

23. A process according to claim 10 to prepare the polymer silica masterbatch of claim 1, wherein the organosilane coupling agent used is selected from γ-aminopropyltriethoxysilane, γ-glycidoxy-propyltrimethoxysilane, bis[3-(triethoxysilyl)propyl]tetrasulfide and vinyl trimethoxysilane, and is more preferably bis[3-(triethoxysilyl)propyl]tetrasulfide and its amount used is between about 1% and about 15% by weight relative to the silica.

24. A process according to claim 10, wherein the dispersing agent used is sodium lauryl ether sulfate or sodium dodecylbenzenesulfonates or NNO (sodium naphthalene-2-sulfonate formaldehyde (1:1:1), and more preferably NNO (sodium naphthalene-2-sulfonate formaldehyde (1:1:1), and its amount used is between about 3% and about 8% by weight relative to the silica.

25. A process according to claim 10, wherein the coagulating agent used is sulfuric acid or acetic acid or formic acid, and more preferably formic acid, and its amount used is between about 3% and about 6% by weight relative to the silica.

26. A process according to claim 10, wherein for the step (a) of compatibilizing the silica particles, heating the said mixture to a temperature at a range of 80° C.-150° C. while it is being stirred in a mixer rotating at a speed range of 30-60 revolution/min and maintaining the heating and stirring for a time range of 1-5 hr.

27. A process according to claim 10 to prepare the polymer silica masterbatch of claim 1, wherein the step (a) of compatibilizing the silica particles is omitted and the compatibilized silica used in the step (b) of forming the emulsion of silica nanoparticles is silica pre-treated or pre-functionalized with a bifunctional organosilane.

28. A process according to claim 10, wherein for the step (b) of forming the emulsion of silica nanoparticles, the additional water used is between about 3 times to about 5 times by weight relative to the silica, the grinding machine is operated at a speed range of 2750-2950 revolution/min and the range of the grinding time is between about 0.2 to about 1 hour.

29. A process according to claim 10, further comprising, in the step of mixing the silica emulsion with the polymer latex (c), admixing one or more ingredients into the resulting polymer latex mixture selected from the group consisting of processing oils, carbon black, talc, clay, stabilizer, antidegradants, zinc salts, waxes and resins.

30. A process according to claim 10, further comprising recovering the dried solid of polymer-silica masterbatch, wherein the polymer latex contains an amount of dry polymer, wherein the weight ratio of the amount of dry polymer to silica is within the range of 100/15 and 100/150, and wherein the solid content of the silica masterbatch is greater than about 20%

31. A process according to claim 30, further comprising admixing the silica masterbatch with a rubber composition to make a silica-filled rubber composition; and forming an article of manufacture from the silica-filled rubber composition.

32. A process according to claim 31, wherein the article of manufacture comprises tread for a tire, anti-vibration and support parts, sleeves and belts for automobile and mechanical uses, flooring tiles and floor supports, shoe soles and sporting goods.
